(19) United States
(12) Patent Application Publication
(10) Pub. No.: US 2023/0386212 A1
(43) Pub. Date: Nov. 30, 2023

(54) METHOD AND SYSTEM FOR MONITORING ACTIVITIES AND EVENTS IN REAL-TIME THROUGH SELF-ADAPTIVE AI

(71) Applicant: SKYLARK LABS INC., Bethel, CT (US)

(72) Inventor: AMARJOT SINGH, Bethel, CT (US)

(21) Appl. No.: 18/202,384

(22) Filed: May 26, 2023

Related U.S. Application Data
(60) Provisional application No. 63/346,282, filed on May 26, 2022.

(51) Int. Cl. G06V 20/52; G06V 10/25; G06V 40/16; G06V 20/40

(52) U.S. Cl. CPC G06V 20/52; G06V 10/25; G06V 40/174; G06V 20/44; G06V 2201/07

(57) ABSTRACT

This disclosure relates to method and system for monitoring activities and events in real-time. The method includes receiving video data of an area from each of one or more cameras. The video data includes a plurality of frames. For each frame of the plurality of frames, the method further includes generating in real-time, a space-time-behaviour dataset corresponding to the frame; identifying in real-time, at least one of an event from a plurality of predefined events, or an associated cause of an event from a plurality of predefined causes, based on the space-time-behaviour dataset; determining in real-time, a set of cause parameters or a set of event parameters, based on the space-time-behaviour dataset; and determining in real-time, whether at least one of the cause or the event corresponds to suspicious activity based on the comparison with parameters of the plurality of predefined causes and the plurality of predefined events.

### TECHNICAL FIELD

This disclosure relates generally to surveillance or monitoring of activities, and more particularly to method and system for monitoring activities and events in real-time through self-adaptive Artificial Intelligence (AI).

### BACKGROUND

Countries worldwide are faced with a challenge of managing external and internal security threats. Globally, terrorism has always been a challenge and in the present digital age, it has evolved and has also become difficult to manage. Domestically, the rate of crimes and other threats to public safety are on the rise. Threats like these may have serious consequences and negative influence on society and individual.

In the present state of art, law enforcement agencies have been motivated to use video surveillance techniques and security systems to monitor and curb such security threats. Primary intent of such systems is to prevent the crime from happening in the first place, and to promptly process help when or if the crime is committed.

Conventional crime prevention techniques make use of facial recognition technology to identify criminals by obtaining video data of a crime scene through a plurality of CCTV cameras installed at various places. Although these techniques help in evidence collection, they are unsuccessful in preventing crime in advance.

Also, in the conventional security systems, accuracy of facial recognition is usually hampered due to poor image quality of the CCTV cameras. Additionally, in most cases, the criminals may disguise their faces, for example, by wearing masks. Some conventional techniques apply facial recognition for monitoring activities in real-time. However, such techniques also fail to predict (and therefore, prevent) the the crime in advance.

Conventional techniques fail to accurately identify the behaviour of individuals and identification of individuals involved in criminal activities or suspicious activities. The behaviour of individuals can correspond to various causes that lead to an event. For example, a cause such as stalking may lead to multiple undesirable events that may not be known to models used by existing techniques. On the other hand, known events can be carried out by new unknown causes. For example, a murderer can come up with new ways of killing someone. The present techniques fail to find meaningful correlation between causes and events. Also, traditional techniques use image-based techniques to analyse the events which is generally not sufficient.

Further, such techniques are not able to detect known and unknown threats/events in real-time. A robust security system should be able to detect threats/events regardless of whether they are known or unknown at the time. Certain events have common root causes or underlying patterns which the conventional techniques fail to identify. Additionally, techniques that can alert or provide early warning for such incidents do not exist.

Therefore, there is a need in the present state of art for an improved real-time system and method for monitoring activities and events in real-time to provide early warning signals for security breaches.

### SUMMARY

In one embodiment, a method for monitoring activities and events in real-time is disclosed. In one example, the method may include receiving video data of an area from each of one or more cameras. The video data may include a plurality of frames. For each frame of the plurality of frames, the method may further include generating in real-time, by an Artificial Intelligence (AI) model, a space-time-behaviour dataset corresponding to the frame. The space-time-behaviour dataset may include spatial data, temporal data, and behavioural data corresponding to the area. The behavioural data may correspond to actions and facial expressions of one or more humans present in the frame. For each frame of the plurality of frames, the method may further include identifying in real-time, by the AI model, at least one of an event from a plurality of predefined events, or an associated cause of an event from a plurality of predefined causes, based on the space-time-behaviour dataset. Each of the plurality of predefined causes may be associated with a predefined space-time-behaviour dataset. For each frame of the plurality of frames, the method may further include determining in real-time, by the AI model, at least one of a set of cause parameters corresponding to the cause or a set of event parameters corresponding to the event, based on the space-time-behaviour dataset. For each frame of the plurality of frames, the method may further include comparing in real-time, by the AI model, the set of cause parameters with corresponding cause parameters of the plurality of predefined causes, and the set of event parameters with corresponding event parameters of the plurality of predefined events. For each frame of the plurality of frames, the method may further include determining in real-time, by the AI model, whether at least one of the cause or the event corresponds to suspicious activity based on the comparison.

In one embodiment, a system for monitoring activities and events in real-time is disclosed. In one example, the system includes a processor and a computer-readable medium communicatively coupled to the processor. The computer-readable medium may store processor-executable instructions, which, on execution, cause the processor to receive video data of an area from each of one or more cameras. The video data may include a plurality of frames. For each frame of the plurality of frames, the processor-executable instructions, on execution, may further cause the processor to generate in real-time, by an Artificial Intelligence (AI) model, a space-time-behaviour dataset corresponding to the frame. The space-time-behaviour dataset may include spatial data, temporal data, and behavioural data corresponding to the area. The behavioural data may correspond to actions and facial expressions of one or more humans present in the frame. For each frame of the plurality of frames, the processor-executable instructions, on execution, may further cause the processor to identify in real-time, by the AI model, at least one of an event from a plurality of predefined events, or an associated cause of an event from a plurality of predefined causes, based on the space-time-behaviour dataset. Each of the plurality of predefined causes may be associated with a predefined space-time-behaviour dataset. For each frame of the plurality of frames, the processor-executable instructions, on execution, may further cause the processor to determine in real-time, by the AI model, at least one of a set of cause parameters corresponding to the cause or a set of event parameters corresponding to the event, based on the space-time-behaviour dataset. For each frame of the plurality of frames, the processor-executable instructions, on execution, may further cause the processor to compare in real-time, by the AI model, the set of cause parameters with corresponding cause parameters of the plurality of predefined causes, and the set of event parameters with corresponding event parameters of the plurality of predefined events. For each frame of the plurality of frames, the processor-executable instructions, on execution, may further cause the processor to determine in real-time, by the AI model, whether at least one of the cause or the event corresponds to suspicious activity based on the comparison.

In one embodiment, a non-transitory computer-readable medium storing computer-executable instructions for monitoring activities and events in real-time is disclosed. In one example, the stored instructions, when executed by a processor, may cause the processor to perform operations including receiving video data of an area from each of one or more cameras. The video data may include a plurality of frames. For each frame of the plurality of frames, the operations may further include generating in real-time, by an Artificial Intelligence (AI) model, a space-time-behaviour dataset corresponding to the frame. The space-time-behaviour dataset may include spatial data, temporal data, and behavioural data corresponding to the area. The behavioural data may correspond to actions and facial expressions of one or more humans present in the frame. For each frame of the plurality of frames, the operations may further include identifying in real-time, by the AI model, at least one of an event from a plurality of predefined events, or an associated cause of an event from a plurality of predefined causes, based on the space-time-behaviour dataset. Each of the plurality of predefined causes may be associated with a predefined space-time-behaviour dataset. For each frame of the plurality of frames, the operations may further include determining in real-time, by the AI model, at least one of a set of cause parameters corresponding to the cause or a set of event parameters corresponding to the event, based on the space-time-behaviour dataset. For each frame of the plurality of frames, the operations may further include comparing in real-time, by the AI model, the set of cause parameters with corresponding cause parameters of the plurality of predefined causes, and the set of event parameters with corresponding event parameters of the plurality of predefined events. For each frame of the plurality of frames, the operations may further include determining in real-time, by the AI model, whether at least one of the cause or the event corresponds to suspicious activity based on the comparison.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates an exemplary system for monitoring activities and events in real-time, in accordance with some embodiments of the present disclosure;

FIG. 2 illustrates an exemplary process for monitoring activities and events in real-time, in accordance with some embodiments of the present disclosure;

FIG. 3 illustrates an exemplary process for self-adaptively training an Artificial Intelligence (AI) model, in accordance with some embodiments of the present disclosure;

FIG. 4 illustrates a detailed exemplary process for monitoring activities and events in real-time, in accordance with some embodiments of the present disclosure;

FIGS. 5A, 5B, 5C, and 5D illustrate a first exemplary scenario of monitoring a suspicious activity in real-time through a self-adaptive AI model, in accordance with an embodiment of the present disclosure;

FIGS. 6A and 6B illustrate a second exemplary scenario of monitoring a suspicious activity in real-time through the self-adaptive AI model, in accordance with an embodiments of the present disclosure;

FIGS. 7A and 7B illustrate a third exemplary scenario of monitoring a suspicious activity in real-time through the self-adaptive AI model, in accordance with some embodiments of the present disclosure; and

FIG. 8 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

For understanding of the person skilled in the art, the term “event or critical event” as used herein refers to an activity that may cause physical and/or property damage, and the term “threat or activity” as used herein refers to any action or set of actions that poses a possibility of leading to such event or critical event. By way of an example, the term event or critical event may include criminal or abnormal activities or security incidents such as, but not limited to, violence, gun violence, child abduction, car robbery, kidnapping, chain snatching, molestation, lurking, theft, etc.

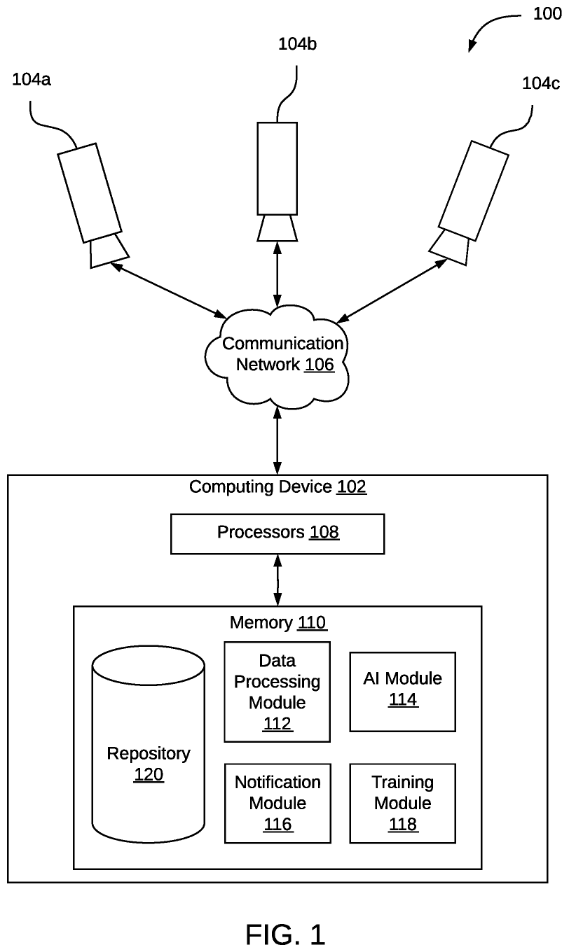

Referring now to FIG. 1, an exemplary system 100 for monitoring activities and events in real-time is illustrated, in accordance with some embodiments of the present disclosure. The system 100 may include a computing device 102 (for example, server, desktop, laptop, notebook, netbook, tablet, smartphone, mobile phone, or any other computing device). Further, the system 100 may include one or more cameras (for example, a camera 104a, a camera 104b, and a camera 104c) communicatively coupled with the computing device 102 via a communication network 106. Examples of the communication network 104 may include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and a combination thereof. Further, the computing device 102 may include one or more processors 108 and a memory 110. The memory 110 may include a data processing module 112, an Artificial Intelligence (AI) module 114, a notification module 116, a training module 118, and at least one repository 120.

The cameras 104a, 104b, and 104c may be Closed Circuit Television (CCTV) cameras (such as dome camera, bullet camera, wide dynamic camera, Pan Tilt Zoom (PTZ) camera, day/night camera, Internet Protocol (IP) camera, thermographic camera, etc.), digital cameras, smartphone cameras, or any other video capturing device capable of real-time video data transmission. The cameras 104a, 104b, and 104c may capture video of an area (for example, a public place (such as a street, a monument, a museum, a market, a stadium, a tourist spot, international border, or the like) or a private place (such as a house, backyard, garage, or the like)). Further, the cameras 104a, 104b, and 104c may transmit the video or corresponding video data to the computing device 102 through the communication network 106. It should be noted that the video data may include a plurality of frames. The data processing module 112 may receive the video data from the cameras 104a, 104b, and 104c. Further, the data processing module 112 may perform pre-processing of the video data. Further, the data processing module 112 may send the video data to the AI module 114.

The AI module 114 may include a self-adaptive AI model. For each frame of the plurality of frames, the AI module 114 may generate in real-time, a space-time-behaviour dataset corresponding to the frame. The space-time-behaviour dataset may include spatial data, temporal data, and behavioural data corresponding to the area. The behavioural data may correspond to actions and facial expressions of one or more humans present in the frame. It should be noted that the term “humans” as used in the present disclosure is not limiting to biological humans and can be used interchangeably to refer any living being capable of performing an activity that can lead to a critical event such as, but not limited to, an intelligent animal (e.g., primates, dogs, etc.) or aliens.

Further, the AI module 114 may identify in real-time, an event from a plurality of predefined events based on the space-time-behaviour dataset. The AI module 114 may also identify in real-time, an associated cause of an event from a plurality of predefined causes based on the space-time-behaviour dataset. It may be noted that each of the plurality of predefined causes may be associated with a predefined space-time-behaviour dataset. Also, the plurality of predefined events and the associated plurality of predefined causes may be stored in the repository 120. It should be noted that a single repository 120 is shown for illustrative purposes but in some embodiments, the computing device 102 may include more than one repository. In an embodiment, the computing device 102 may include an events repository for storing the plurality of predefined events and a cause repository for storing the plurality of predefined causes.

Further, the AI module 114 may determine in real-time, at least one of a set of cause parameters corresponding to the cause or a set of event parameters corresponding to the event, based on the space-time-behaviour dataset. Further, the AI module 114 may compare in real-time, the set of cause parameters with corresponding cause parameters of the plurality of predefined causes, and the set of event parameters with corresponding event parameters of the plurality of predefined events. Further, the AI module 114 may determine in real-time, whether at least one of the cause or the event corresponds to suspicious activity based on the comparison.

It should be noted that to determine whether at least one of the cause or the event corresponds to suspicious activity, the AI module 114 may analyse the space-time-behaviour dataset. The analysis may include processing of behavioural data of the one or more humans present in the frame, and the spatial data and the temporal data of the area. The analysis may further include a comparison of the behavioural data, the spatial data, and the temporal data with a plurality of predefined cause parameters and a plurality of predefined event parameters. In an embodiment, the behavioural-space-time dataset may be stored in the at least one repository 120. In other words, the at least one repository 120 may store predefined behavioural patterns corresponding to one or more suspicious activities. The predefined behavioural patterns may be general behaviours or behaviours customized for a particular person or location.

Further, the analysis may include recognition of any appropriate behavioural patterns or features, such as those relating to expressions, poses, glasses, masks, weapons, actions, and the like. The AI module 114 may process the behavioural data in order to determine the content and/or result data. This can include, for example, analyzing rules or policies for the security personnel from a security repository of the at least one repository 120, rules or data for specific human or occurrences from a human behaviour repository of the at least one repository 120, and the analysis of any data that can provide information useful in determining an appropriate response. The output data can be transmitted to an external device in any appropriate form and/or format that can be directly imported and interpreted by a software executed on the external device. In some embodiments, additional components or processes can be utilized to help track an event over time, even when such an event might cease to happen but then reappear at a later time instance, or appear in different camera feeds. Such software can also be used to correlate events, such as violence, gun violence, child abduction, car robbery, kidnapping, chain snatching, molestation, lurking, theft, etc.

In another embodiment, the AI module 114 may automatically discover causes (indicators) of events emerging at different locations to provide proactive alerts for security incidents.

In a preferred embodiment, the AI module 114 may detect known and unknown threats/events based on the human behaviours (for a group of humans as well as individual humans) to provide early warning signals for security incidents. In case when the computing device 102 identifies an event for the first time, the self-adaptive AI model may recognize and store the patterns associated with the event and the associated causes that led to the event in the at least one repository 120. Further, when such event or causes may be identified at a later time instance, the computing device 102 may then provide early warning signals to prevent the event from occurring again.

When the at least one of the cause or the event is determined as a suspicious activity, the notification module 116 may notify in real-time, an administrator of the determined suspicious activity. The administrator may receive the notification through the computing device 102 or an administrator device communicably connected to the computing device 102. In an embodiment, the computing device 102 may render the notification on a Graphical User Interface (GUI) of the computing device 102 or the administrator device.

Further, when the at least one of the cause or the event is determined as a suspicious activity, the AI module 114 may automatically update the at least one repository 120 with the set of cause parameters and the set of event parameters. Further, the training module 118 may train the self-adaptive AI model of the AI module 114 using the at least one updated repository 120. To train the self-adaptive AI model, the training module 118 may modify in real-time or near real-time, a set of parameters of the self-adaptive AI model based on the at least one updated repository 120.

In some embodiments, the at least one repository 120 may include a signature library corresponding to each of a plurality of suspicious activities. The signature library corresponding to a suspicious activity may include a set of patterns associated with the suspicious activity. The set of patterns may correspond to human behaviours in context of the spatial data and the temporal data. For example, if the suspicious activity is open firing in a public place, the set of patterns may include walking while holding a firearm in a crowded place and cautiously looking around the place to check for security lapses. Such a set of patterns may be stored in the signature library corresponding to open firing.

Also, in some embodiments, the at least one repository 120 may include a geolocation-specific library corresponding to each of a plurality of suspicious activities and a shared signature library. The geolocation-specific library may include the predefined space-time-behaviour dataset corresponding to a geolocation. The shared signature library may include the predefined space-time-behaviour dataset corresponding to each of a set of geolocations. The computing device 102 may store the causes/events from different geolocations (i.e., the set of geolocations) to construct a shared signature library. The shared signature library may be updated in real-time to account for emerging causes/events in particular locations. This update may allow the computing device 102 to provide early warning signals (or alerts) for a possible threat/event at a geolocation for similar emerging threats/events from other monitored geolocations or controlled environments.

In some embodiments, the AI module 114 may identify in real-time, one or more humans present in the frame using conventional techniques, such as a facial recognition algorithm. Further, when the at least one of the cause or the event is determined as a suspicious activity, the AI module 114 may store identification details of the one or more humans in the at least one repository 120. Further, at a later time instance, the one or more humans may be identified through the identification details in a subsequent frame performing at least one of a premature cause or a cause associated with a suspicious activity, at the same location or at a different location. Then, the notification module 116 may notify in real-time, an administrator at the later time instance. This may enable the administrator to scrutinize and/or increase security in the area or take any other appropriate action, as may be required, to prevent an event from taking place.

Thus, the computing device 102 may detect known and unknown events corresponding to groups as well as individuals to provide early warning signals for security incidents. In some embodiments, the computing device 102 can self-discover and adapt to the causes of critical events via the self-adaptive AI model. Then, whenever the said causes recur, the computing device 102 may provide proactive alerts before that critical event/threat takes place. Additionally, since there are a lot of other critical events/threats associated with the same cause discovered earlier by the self-adaptive AI model, this allows the computing device 102 to proactively alert for the unknown threats/events as well. For example, stalking a person may be a cause that can lead to multiple events such as, kidnapping, assault, homicide, serial killing, mass killing, or the like. Therefore, when the self-adaptive AI model establishes that stalking is a suspicious activity, any subsequent incident identified as stalking by the self-adaptive AI will be highlighted and the administrator may be notified to prevent any such event from taking place, even if such event is unknown (i.e., not recognized as suspicious activity by the self-adaptive AI model so far).

In some embodiments, the cameras 104a, 104b, and 104c may share the video with one or more external devices (not shown in figure) through the communication network 106. The external devices may include a television, a computer, a smartphone, or any other electronic device that may be capable of broadcasting, and optionally, recording the video.

In some embodiments the behavioural data is shared with the AI module 114 which can then determine one or more actions to take. Further, the notification module 116 may then provide appropriate notifications or instructions, whether to the computing device 102, the administrator device (such as device of a security personnel), or a device operated by a third party security provider (such as a security company or police department). Such devices may maintain an alert criteria that indicates an action to be taken in response to a particular alert or notification. Before such alerts are sent, in some embodiments, there may be at least some level of verification, authentication, or authorization performed with respect to the request or video data.

In an embodiment, the AI module 114 may provide automatic discovery of causes (indicators) responsible for an event. The self-adaptive AI may discover common and individual-specific threat causes by collectively analysing suspicious behaviours with event characteristics responsible for known security incidents. The emergence of causes of the threats along with certain suspicious behaviours can be used to proactively alert for impending threatening behaviours or individuals.

In another embodiment, the self-adaptive AI model may monitor real-time continuous evolution of unknown threats using the discovered causes (indicators), which is defined in terms of behavioural-space-time. These discovered causes and suspicious behaviours can evolve over time to produce new unknown threats/events. The system 100 can evolve accordingly in real-time to keep up with these new and changing threats/events. This real-time adaption is essential as traditional alternatives, such as fine-tuning for new threats/events maybe ill-suited and unnecessary as the new threats/events may only last for a short period. At the same time, the system 100 must respond to these short-lived threats/events making real-time continuous learning a must-have feature.

In the embodiments, the cause is defined in terms of the behavioural-space-time data, which includes scene characteristics (such as location, time of the day, pedestrian's density, ages, genders, etc) and human behaviours (such as facial expressions, emotions, body language, actions, etc.) analysed through time. Once a common cause of a specific critical event has been discovered, the system 100 can proactively detect that critical event/threat even before it happens. Since now the system 100 knows what leads to that specific critical event/threat and also discovers a new behavioural-space-time dataset that leads to some critical event/threat, this allows the system 100 to proactively detect unknown new threats as well which are followed by that discovered behavioural-space-time dataset. This wouldn't be possible without discovering the causes of known critical events.

It should be noted that the suspicious behaviour in certain crime conducive conditions or cause leads to a threat. The system 100 flags the threat based on the above. In addition, the system 100 also has an ability to identify new threats if they occur in one or more of the crime conducive conditions or causes, and vice versa. Therefore, there are two aspects to functioning of the system 100: identification and new discovery.

For example, the system 100 is configured to detect a car robbery. In which, the system 100 discovers the behavioural-space-time dataset that leads to a car robbery (for example, a pedestrian covering his face, lurking around a car, carrying a long rod look-alike structure, and the like). So, in future, if the system 100 identifies a similar behavioural-space-time dataset, the system 100 may accurately predict the car robbery even before the thief robs the car.

Accordingly, in a similar manner, the behavioural-space-time dataset may also lead to several other unknown critical events that the system 100 has not previously detected, such as shop robbery, ATM robbery, vandalism, etc. Since, the system 100 is configured with the behavioural-space-time dataset that leads to a critical event, this allows the system 100 to proactively detect all those unknown critical events which are followed by the specific behavioural-space-time dataset.

In some embodiments security agencies or security personnel might also utilize personal computing devices that are able to receive video feeds or other notifications discussed herein. In some embodiments, the security agencies or security personnel can utilize the service to obtain information relating to threats or events, as may relate to security monitoring, such as but not limited to, violence, gun violence, child abduction, car robbery, kidnapping, chain snatching, molestation, lurking, theft, etc.

It should be noted that all such aforementioned modules 112-120 may be represented as a single module or a combination of different modules. Further, as will be appreciated by those skilled in the art, each of the modules 112-120 may reside, in whole or in parts, on one device or multiple devices in communication with each other. In some embodiments, each of the modules 112-120 may be implemented as dedicated hardware circuit comprising custom application-specific integrated circuit (ASIC) or gate arrays, off-the-shelf semiconductors such as logic chips, transistors, or other discrete components. Each of the modules 112-120 may also be implemented in a programmable hardware device such as a field programmable gate array (FPGA), programmable array logic, programmable logic device, and so forth. Alternatively, each of the modules 112-120 may be implemented in software for execution by various types of processors (e.g., processors 108). An identified module of executable code may, for instance, include one or more physical or logical blocks of computer instructions, which may, for instance, be organized as an object, procedure, function, or other construct. Nevertheless, the executables of an identified module or component need not be physically located together, but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for monitoring activities and events in real-time. For example, the exemplary system 100 and the associated computing device 102 may monitor activities and events in real-time by the processes discussed herein. In particular, as will be appreciated by those of ordinary skill in the art, control logic and/or automated routines for performing the techniques and steps described herein may be implemented by the system 100 and the computing device 102 either by hardware, software, or combinations of hardware and software. For example, suitable code may be accessed and executed by the one or more processors on the system 100 and the computing device 102 to perform some or all of the techniques described herein. Similarly, application specific integrated circuits (ASICs) configured to perform some or all of the processes described herein may be included in the one or more processors on the computing device 102.

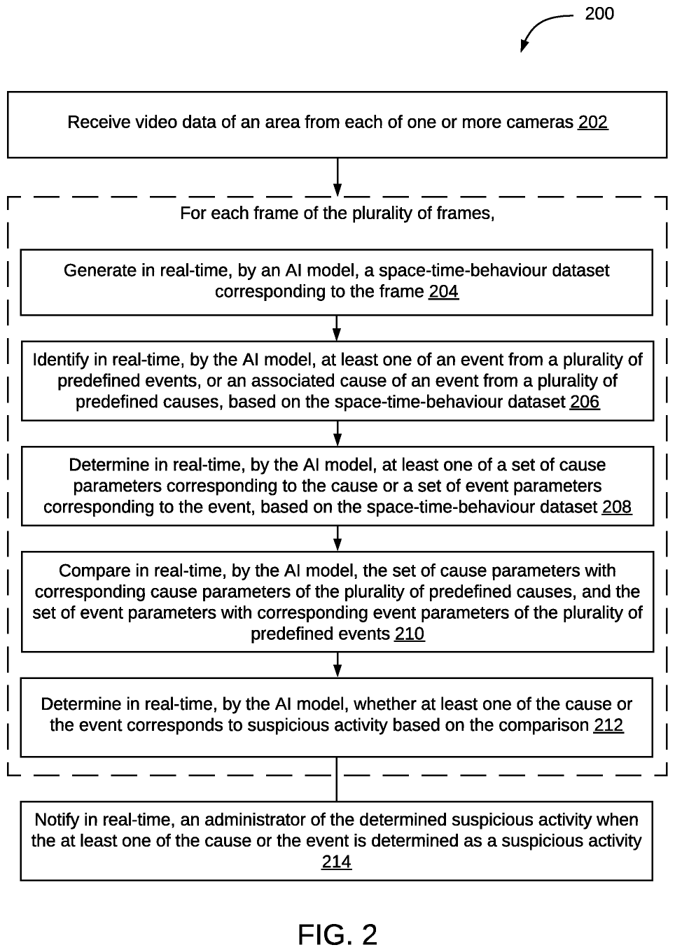

Referring now to FIG. 2, an exemplary process 200 for monitoring activities and events in real-time is depicted via a flow chart, in accordance with some embodiments of the present disclosure. FIG. 2 is explained in conjunction with elements from FIG. 1. In an embodiment, the process 200 may be implemented by the computing device 102 of the system 100. The process 200 may include receiving, by the data processing module 112, video data of an area from each of one or more cameras, at step 202. The video data may include a plurality of frames. Further, for each frame of the plurality of frames, the process 200 may include generating in real-time, by the AI module 114, a space-time-behaviour dataset corresponding to the frame, at step 204. The space-time-behaviour dataset may include spatial data, temporal data, and behavioural data corresponding to the area. The behavioural data may correspond to actions and facial expressions of one or more humans present in the frame.

Further, for each frame of the plurality of frames, the process 200 may include identifying in real-time, by the AI module 114, at least one of an event from a plurality of predefined events, or an associated cause of an event from a plurality of predefined causes, based on the space-time-behaviour dataset, wherein each of the plurality of predefined causes is associated with a predefined space-time-behaviour dataset, at step 206.

Further, for each frame of the plurality of frames, the process 200 may include determining in real-time, by the AI module 114, at least one of a set of cause parameters corresponding to the cause or a set of event parameters corresponding to the event, based on the space-time-behaviour dataset, at step 208.

Further, for each frame of the plurality of frames, the process 200 may include comparing in real-time, by the AI module 114, the set of cause parameters with corresponding cause parameters of the plurality of predefined causes, and the set of event parameters with corresponding event parameters of the plurality of predefined events, at step 210.

Further, for each frame of the plurality of frames, the process 200 may include determining in real-time, by the AI module 114, whether at least one of the cause or the event corresponds to suspicious activity based on the comparison, at step 212.

Further, the process 200 may include notifying in real-time, by the notification module 116, an administrator of the determined suspicious activity when the at least one of the cause or the event is determined as a suspicious activity, at step 214.

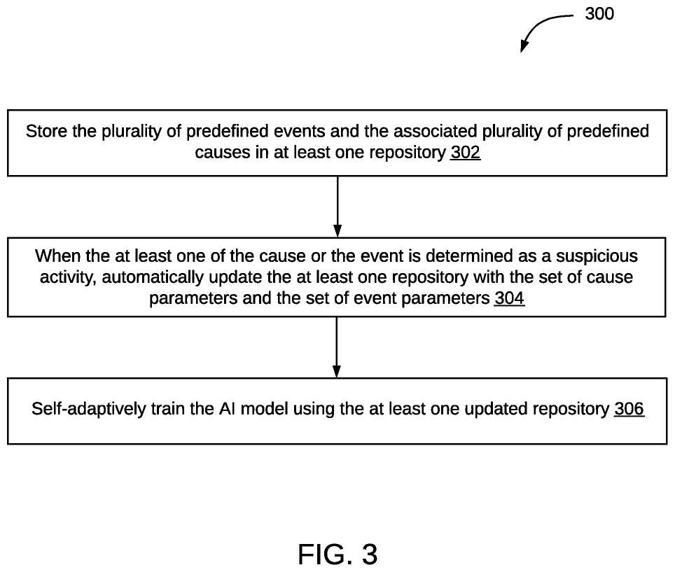

Referring now to FIG. 3, an exemplary process 300 for self-adaptively training the AI model is depicted via a flow chart, in accordance with some embodiments of the present disclosure. FIG. 3 is explained in conjunction with elements from FIGS. 1 and 2. In an embodiment, the process 300 may be implemented by the computing device 102 of the system 100. It should be noted that one or more steps of the process 300 may be implemented following the implementation of the process 200 or in parallel to some or all the steps of the process 200. The process 300 may include storing, by the data processing module 112, the plurality of predefined events and the associated plurality of predefined causes in at least one repository (e.g., the repository 120), at step 302.

The at least one repository may include a signature library corresponding to each of a plurality of suspicious activities. In some embodiments, the at least one repository may include a geolocation-specific library corresponding to each of a plurality of suspicious activities and a shared signature library. The geolocation-specific library may include the predefined space-time-behaviour dataset corresponding to a geolocation. The shared signature library may include the predefined space-time-behaviour dataset corresponding to each of a set of geolocations.

Further, the process 300 may include, when the at least one of the cause or the event is determined as a suspicious activity (by step 212 of the process 200), automatically updating, by the data processing module 112, the at least one repository with the set of cause parameters and the set of event parameters, at step 304.

Further, the process 300 may include self-adaptively training, by the training module 118, the AI model using the at least one updated repository, at step 306. To adaptively train the AI model, the step 306 of the process 300 may include modifying in real-time or near real-time, by the training module 118, a set of parameters of the AI model based on the at least one updated repository, at step 308.

In some embodiments, the process 300 may include identifying in real-time, by the AI module 114, one or more humans present in the frame. The identification of the one or more humans may be performed using a facial recognition algorithm. Further, in such embodiments, the process 300 may include, when the at least one of the cause or the event is determined as a suspicious activity, storing identification details of the one or more humans in the at least one repository. Further, in such embodiments, the process 300 may include notifying in real-time, by the notification module 116, an administrator at a subsequent time instance when in a subsequent frame: (i) the one or more humans are identified through the identification details, and (ii) at least one of a premature cause or a cause associated with a suspicious activity is identified. In other words, when the previously identified humans are caught performing the same or any other suspicious activity, the administrator may be proactively notified in advance so that any potential event may be prevented.

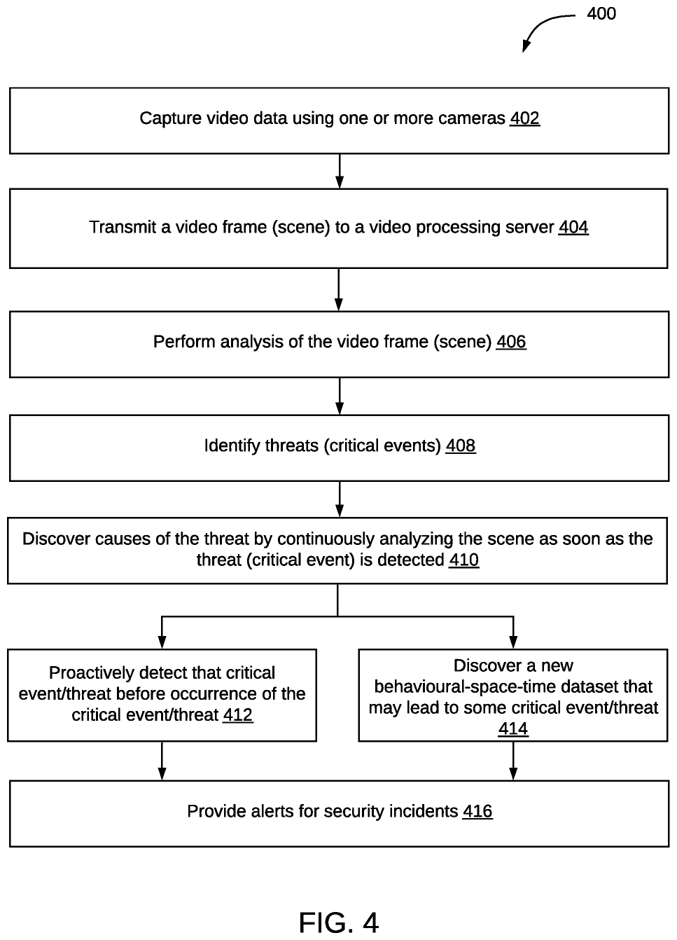

Referring now to FIG. 4, a detailed exemplary process 400 for monitoring activities and events in real-time is depicted via a flow chart, in accordance with some embodiments of the present disclosure. FIG. 4 is explained in conjunction with elements from FIGS. 1, 2, and 3. In an embodiment, the process 400 may be implemented by the computing device 102 of the system 100. It should be understood that, for any process discussed herein, there can be additional, fewer, or alternative steps performed in similar or alternative orders, or in parallel, within the scope of the various embodiments unless otherwise stated. According to some implementations of the present invention, the process 400 is described herein with various steps without departing from the scope of the invention. The process 400 may include capturing video data using one or more cameras (for example, the camera 104a, the camera 104b, and the camera 104c), at step 402. Each of the one or more cameras captures/records one or more image(s) and/or video(s) corresponding to an area. Each of the one or more cameras can perform constant capturing/recording, and/or can be activated to capture/record based on a specific schedule.

Further, the process 400 may include transmitting, by the one or more cameras and via the communication network 106, a video frame (scene) to a video processing server (such as the computing device 102), at step 404. Further, the process 400 may include performing, by the AI module 114, analysis of the video frame (scene), at step 406. Further, the process 400 may include identifying, by the AI module 114, threats (critical events), at step 408. Further, the process 400 may include discovering causes of the threat by continuously analyzing the scene as soon as the threat (critical event) is detected, at step 410. In some embodiments, the cause may be defined as in terms of behaviour-space-time data. The behaviour-space-time data may include scene characteristics (such as, location, time of the day, pedestrian's density, ages, genders, etc.) and human behaviours (such as, facial expressions, emotions, actions, body language, etc.) analyzed through time.

Further, upon discovering the causes of a specific critical event, the process 400 may include proactively detecting that critical event/threat before occurrence of the critical event/threat, at step 412. Since the AI model has been trained using the behaviour-space-time data of that critical event/threat, once the causes are identified, the AI model can predict a possibility of occurrence of the critical event. Additionally, upon discovering the causes of the specific critical event, the process 400 may include discovering a new behavioural-space-time dataset (i.e., previously unidentified patterns) that may lead to some critical event/threat, at step 414. This allows the computing device 102 to proactively predict unknown and new threats which are followed by the newly discovered behavioural-space-time. Further, following either of the steps 412 or 414, the process 400 may include proactively providing, by the notification module 116, alerts for security incidents, at step 416. Once known and unknown events for human groups as well as individuals are detected, the notification module 116 may provide early warning signals for security incidents.

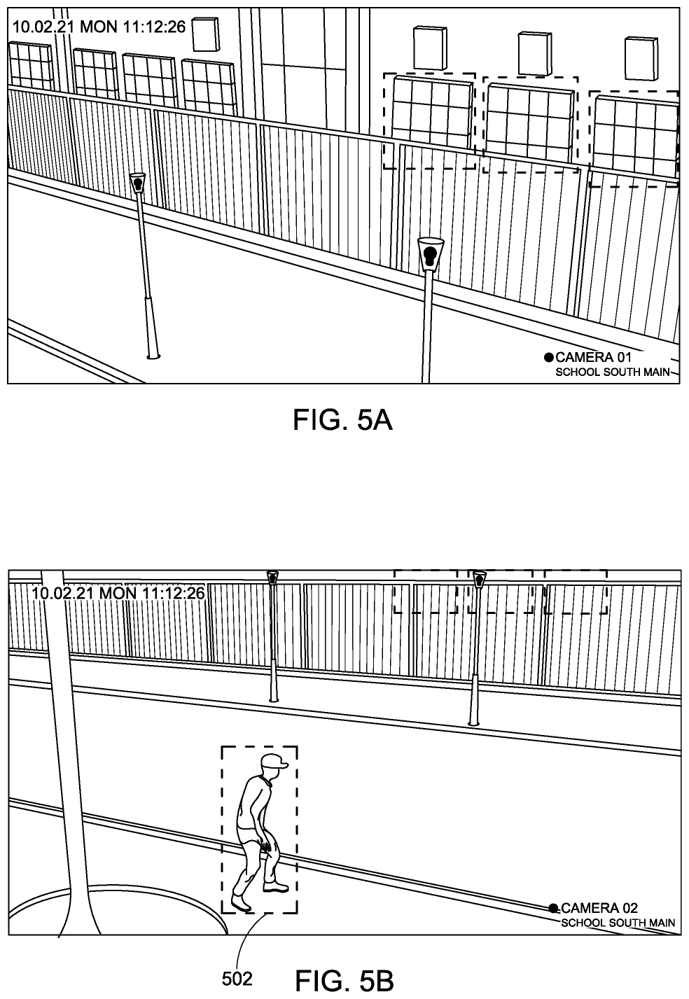

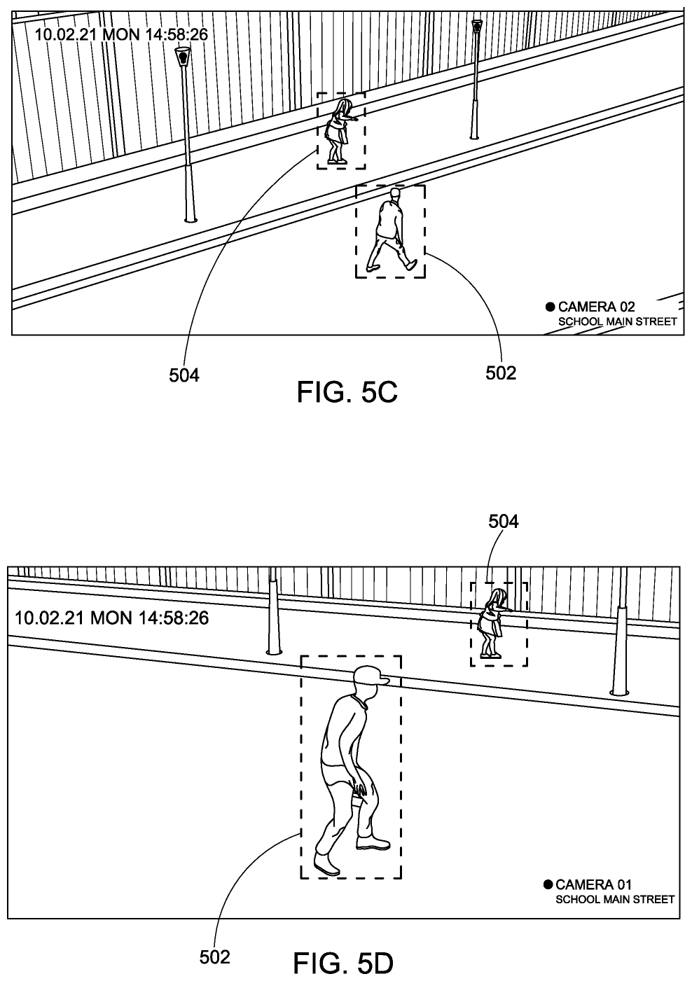

Referring now to FIGS. 5A, 5B, 5C, and 5D, a first exemplary scenario of monitoring a suspicious activity in real-time through a self-adaptive AI model is illustrated, in accordance with an embodiment of the present disclosure. FIGS. 5A-D are explained in conjunction with elements from FIGS. 1, 2, 3, and 4. By way of an example, the suspicious activity may be kidnapping. As discussed above, the computing device 102 is configured to detect various threats/events. In FIG. 5A, a first video frame of an area (e.g., a street) is shown in which no individual is present. In FIG. 5B, a second video frame of the area is shown where an adult person 302 is walking on the street. The second video frame is captured at a later time instance than that of the first video frame. In FIG. 5C, a third video frame of the area is shown where a child 504 is walking alone on the street and is followed along by the adult person 502. The third video frame is captured at a later time instance than that of the second video frame. In FIG. 5D, a fourth video frame is shown where the adult 502 is coming closer to the child 504. The fourth video frame is captured at a later time instance than that of the third video frame. The system 100 is online and may continuously monitor the area. The one or more cameras 104a, 104b, and 104c may record multiple observations to generate the behavioural-space-time dataset that may provide the AI module 114 with a set of patterns corresponding to kidnapping. From this example, it is apparent that a person is lurking around a space near an alone child with no adults around. The person lurks for a few minutes, then at the right opportunity, approaches the child and attempts to abduct.

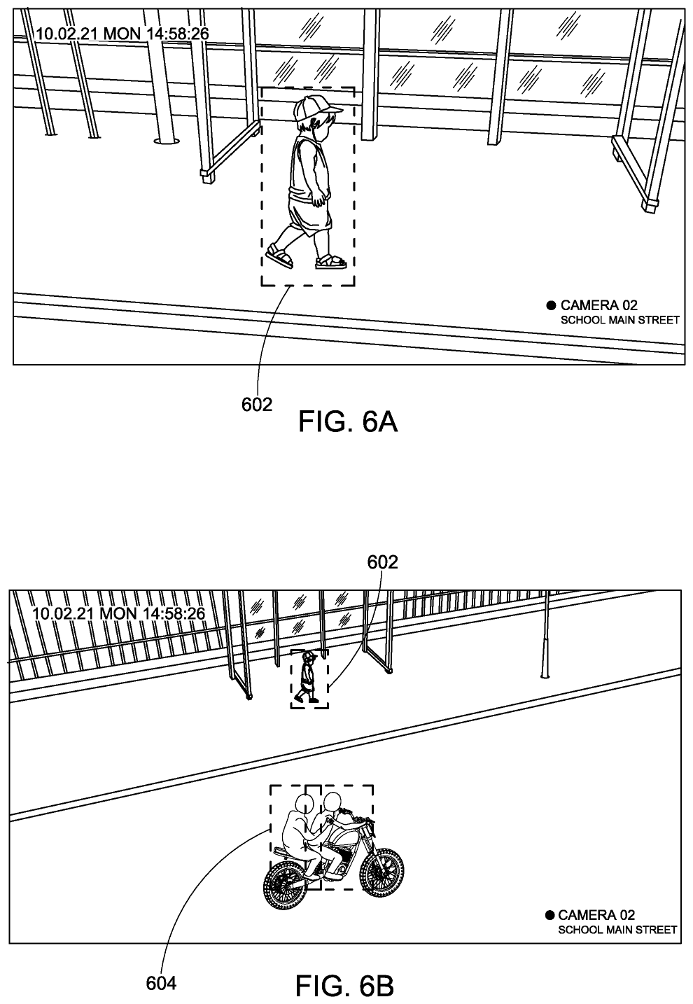

Referring now to FIGS. 6A and 6B, a second exemplary scenario of monitoring a suspicious activity in real-time through the self-adaptive AI model is illustrated, in accordance with an embodiment of the present disclosure. FIGS. 6A-B are explained in conjunction with elements from FIGS. 1, 2, 3, 4, and 5A-D. In continuation with the example shown in FIGS. 5A-D, the self-adaptive AI model of the AI module 114 has now identified a set of patterns associated with child kidnapping from a street. In FIG. 6A, a first video frame is shown where an alone child 602 is waiting at a bus stop. In FIG. 6B, a second video frame is shown where two adults on a bike 404 start lurking around the alone child 402. The second video frame is captured at a later time instance than that of the first video frame.

The self-adaptive AI model has been previously trained to identify lurking as a cause of an event i.e., kidnapping, even though the second video frame may produce a new behaviour-space-time dataset. As such, the self-adaptive AI model may determine that the lurking in the second video frame corresponds to a suspicious activity. Therefore, the notification module 116 may proactively generate an alert to prevent a possible event of child abduction. In other words, the system 100 can proactively detect or predict future child abductions even before they take place whenever a discovered behavioural-space-time dataset or a newly discovered behavioural-space-time dataset is found in an area.

One application of the present invention is in preventing child abduction cases. Child abduction is a menace in the United States and around the world. The self-adaptive AI model may automatically discover abduction-specific threat indicators to provide early warnings of possible child abductions.

These abduction-specific threat causes are discovered from areas populated with children (children parks or schools) by collectively assessing suspicious behaviours of individuals, such as lurking, along with other scene characteristics, such as location (children parks or schools), time, crowd density, adults at the location, proximity to the children, approaching action, coming in contact with children, luring them away from the location, etc.

The system 100 aggregates these threat indicators from different locations to construct an abduction-specific signature library. This signature library is used by the system 100 to look for similar threat indicators at new areas populated with children to proactively alert for individuals attempting child abductions. This signature library also stores offender-specific threat indicators that may be used by the system 100 to provide proactive warnings for offenders if they re-attempt to abduct children at new locations.

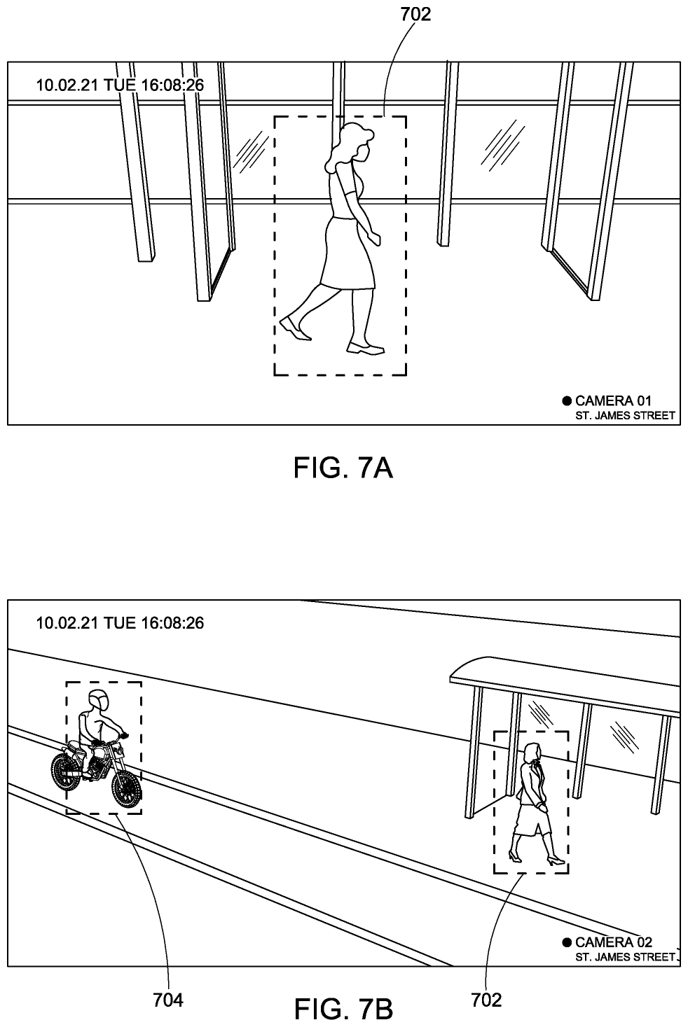

Referring now to FIGS. 7A and 7B, a third exemplary scenario of monitoring a suspicious activity in real-time through the self-adaptive AI model is illustrated, in accordance with an embodiment of the present disclosure. FIGS. 7A-B are explained in conjunction with elements from FIGS. 1, 2, 3, 4, and 5A-D, and 6A-B. In continuation with the example shown in FIGS. 5A-D and 6A-B, the self-adaptive AI model of the AI module 114 has now identified a set of patterns associated with child kidnapping from a street. However, a threat such as chain snatching is unknown to the self-adaptive AI model. In FIG. 7A, a first video frame is shown where an adult woman 702 is waiting alone at a bus stop. In FIG. 7B, a second video frame is shown where a biker 704 is lurking around the woman 702 for a few minutes with an intention to snatch a chain worn by the woman 702. Since, the self-adaptive AI model is trained with similar behavioural-space-time dataset, the notification module 116 may be immediately triggered to provide a proactive alert for a potential unknown critical event (chain snatching in this case).

From these examples as disused above, it is apparent that the system 100 can self-discover and self-adapt to the causes of critical events. Whenever such causes recur, the system 100 can provide proactive alerts before the critical events take place. And, since there are a lot of other critical events associated with same or similar underlying causes discovered earlier by the system 100, this allows the system 100 to proactively alert the administrator for unknown threats as well.

As will be also appreciated, the above described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

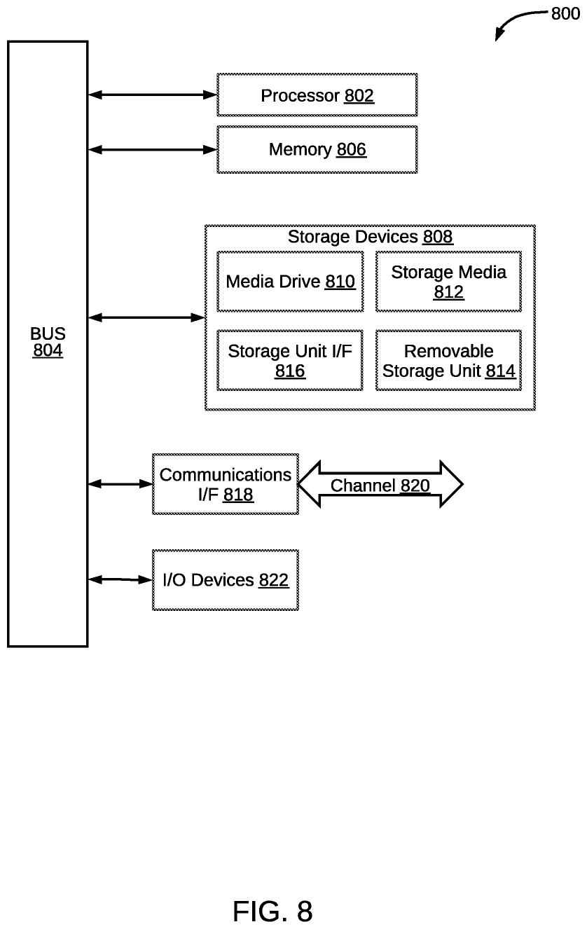

The disclosed methods and systems may be implemented on a conventional or a general-purpose computer system, such as a personal computer (PC) or server computer. Referring now to FIG. 8, an exemplary computing system 800 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 800 may represent, for example, a user device such as a desktop, a laptop, a mobile phone, personal entertainment device, DVR, and so on, or any other type of special or general-purpose computing device as may be desirable or appropriate for a given application or environment. The computing system 800 may include one or more processors, such as a processor 802 that may be implemented using a general or special purpose processing engine such as, for example, a microprocessor, microcontroller or other control logic. In this example, the processor 802 is connected to a bus 804 or other communication medium. In some embodiments, the processor 802 may be an Artificial Intelligence (AI) processor, which may be implemented as a Tensor Processing Unit (TPU), or a graphical processor unit, or a custom programmable solution Field-Programmable Gate Array (FPGA).

The computing system 800 may also include a memory 806 (main memory), for example, Random Access Memory (RAM) or other dynamic memory, for storing information and instructions to be executed by the processor 802. The memory 806 also may be used for storing temporary variables or other intermediate information during execution of instructions to be executed by the processor 802. The computing system 800 may likewise include a read only memory (“ROM”) or other static storage device coupled to bus 804 for storing static information and instructions for the processor 802.

The computing system 800 may also include a storage devices 808, which may include, for example, a media drive 810 and a removable storage interface. The media drive 810 may include a drive or other mechanism to support fixed or removable storage media, such as a hard disk drive, a floppy disk drive, a magnetic tape drive, an SD card port, a USB port, a micro USB, an optical disk drive, a CD or DVD drive (R or RW), or other removable or fixed media drive. A storage media 812 may include, for example, a hard disk, magnetic tape, flash drive, or other fixed or removable medium that is read by and written to by the media drive 810. As these examples illustrate, the storage media 812 may include a computer-readable storage medium having stored therein particular computer software or data.

In alternative embodiments, the storage devices 808 may include other similar instrumentalities for allowing computer programs or other instructions or data to be loaded into the computing system 800. Such instrumentalities may include, for example, a removable storage unit 814 and a storage unit interface 816, such as a program cartridge and cartridge interface, a removable memory (for example, a flash memory or other removable memory module) and memory slot, and other removable storage units and interfaces that allow software and data to be transferred from the removable storage unit 814 to the computing system 800.

The computing system 800 may also include a communications interface 818. The communications interface 818 may be used to allow software and data to be transferred between the computing system 800 and external devices. Examples of the communications interface 818 may include a network interface (such as an Ethernet or other NIC card), a communications port (such as for example, a USB port, a micro USB port), Near field Communication (NFC), etc. Software and data transferred via the communications interface 818 are in the form of signals which may be electronic, electromagnetic, optical, or other signals capable of being received by the communications interface 818. These signals are provided to the communications interface 818 via a channel 820. The channel 820 may carry signals and may be implemented using a wireless medium, wire or cable, fiber optics, or other communications medium. Some examples of the channel 820 may include a phone line, a cellular phone link, an RF link, a Bluetooth link, a network interface, a local or wide area network, and other communications channels.

The computing system 800 may further include Input/Output (I/O) devices 822. Examples may include, but are not limited to a display, keypad, microphone, audio speakers, vibrating motor, LED lights, etc. The I/O devices 822 may receive input from a user and also display an output of the computation performed by the processor 802. In this document, the terms “computer program product” and “computer-readable medium” may be used generally to refer to media such as, for example, the memory 806, the storage devices 808, the removable storage unit 814, or signal(s) on the channel 820. These and other forms of computer-readable media may be involved in providing one or more sequences of one or more instructions to the processor 802 for execution. Such instructions, generally referred to as “computer program code” (which may be grouped in the form of computer programs or other groupings), when executed, enable the computing system 800 to perform features or functions of embodiments of the present invention.

In an embodiment where the elements are implemented using software, the software may be stored in a computer-readable medium and loaded into the computing system 800 using, for example, the removable storage unit 814, the media drive 810 or the communications interface 818. The control logic (in this example, software instructions or computer program code), when executed by the processor 802, causes the processor 802 to perform the functions of the invention as described herein.

Thus, the disclosed method and system try to overcome the technical problem of monitoring activities and events in real-time. The method and system provide detection of various varieties of threats (critical events), such as violence, gun violence, child abduction, car robbery, kidnapping, chain snatching, molestation, lurking, theft, etc. Further, the system can automatically discover the causes of all these threats by continuously analyzing the scene and discovering the cause as soon as some critical event is detected, where a cause is defined in terms of behavioural-space-time data. Behavioural-space-time data is made up of scene characteristics (such as location, pedestrians density, ages, genders, facial expressions, etc) and human behaviours analyzed through time. Further, the system can detect several such suspicious behaviours and automatically find scene conditions conducive to leading threats. Since human behaviour evolves continuously, these threats also evolve to which the system can automatically adapt to learn new behaviours or scene conditions leading to suspicious new threats. Further, the system can do this across different locations to build a collective threat signature library which allows the system to proactively generate alerts (warning signals) for emerging threats in the controlled environments or nearby places or places that are required to be monitored.

As will be appreciated by those skilled in the art, the techniques described in the various embodiments discussed above are not routine, or conventional, or well understood in the art. The techniques discussed above provide for monitoring activities and events in real-time. The system is built with a self-adaptive AI model to discover common and individual-specific threat causes by collectively analyzing suspicious behaviours with event characteristics responsible for known security incidents. The emergence of causes of the threats along with certain suspicious behaviours can be used to proactively alert for impending threatening behaviours or individuals. The system further aggregates causes of the threats/events from different geolocations to construct a shared signature library. This shared signature library is updated in real-time to account for emerging threats/events in particular locations. This update allows relevant geolocations to get early warning signals (alerts) for similar emerging threats/events. The cause is defined in terms of the behavioural-space-time data, which is made up of scene characteristics (such as location, pedestrian's density, ages, genders, facial expressions etc) and human behaviours analyzed through time. Once a common cause of a specific critical event has been discovered, the system can proactively detect that critical event/threat even before it happens. Since now the system knows what leads to that specific critical event/threat and also discovers a new behavioural-space-time that leads to some critical event/threat, this allows the system to proactively detect unknown new threats as well which are followed by that discovered behavioural-space-time.

In light of the above mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described method and system for monitoring activities and events in real-time. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for monitoring activities and events in real-time, the method comprising:
receiving video data of an area from each of one or more cameras, wherein the video data comprises a plurality of frames;
for each frame of the plurality of frames,
generating in real-time, by an Artificial Intelligence (AI) model, a space-time-behaviour dataset corresponding to the frame, wherein the space-time-behaviour dataset comprises spatial data, temporal data, and behavioural data corresponding to the area, and wherein the behavioural data corresponds to actions and facial expressions of one or more humans present in the frame;
identifying in real-time, by the AI model, at least one of:
an event from a plurality of predefined events, or
an associated cause of an event from a plurality of predefined causes,
based on the space-time-behaviour dataset, wherein each of the plurality of predefined causes is associated with a predefined space-time-behaviour dataset;
determining in real-time, by the AI model, at least one of a set of cause parameters corresponding to the cause or a set of event parameters corresponding to the event, based on the space-time-behaviour dataset;
comparing in real-time, by the AI model, the set of cause parameters with corresponding cause parameters of the plurality of predefined causes, and the set of event parameters with corresponding event parameters of the plurality of predefined events; and
determining in real-time, by the AI model, whether at least one of the cause or the event corresponds to suspicious activity based on the comparison.

2. The method of claim 1, further comprising storing the plurality of predefined events and the associated plurality of predefined causes in at least one repository.

3. The method of claim 2, further comprising, when the at least one of the cause or the event is determined as a suspicious activity, automatically updating the at least one repository with the set of cause parameters and the set of event parameters.

4. The method of claim 3, further comprising self-adaptively training the AI model using the at least one updated repository, wherein adaptively training comprises modifying in real-time or near real-time, a set of parameters of the AI model based on the at least one updated repository.

5. The method of claim 2, wherein the at least one repository comprises a signature library corresponding to each of a plurality of suspicious activities.

6. The method of claim 2, wherein the at least one repository comprises a geolocation-specific library corresponding to each of a plurality of suspicious activities and a shared signature library, wherein the geolocation-specific library comprises the predefined space-time-behaviour dataset corresponding to a geolocation, and wherein the shared signature library comprises the predefined space-time-behaviour dataset corresponding to each of a set of geolocations.

7. The method of claim 2, further comprising:
identifying in real-time, by the AI model, one or more humans present in the frame;
when the at least one of the cause or the event is determined as a suspicious activity, storing identification details of the one or more humans in the at least one repository; and
notifying in real-time, an administrator at a subsequent time instance when in a subsequent frame:
the one or more humans are identified through the identification details, and
at least one of a premature cause or a cause associated with a suspicious activity is identified.

8. The method of claim 1, further comprising, notifying in real-time, an administrator of the determined suspicious activity when the at least one of the cause or the event is determined as a suspicious activity.

9. A system for monitoring activities and events in real-time, the system comprising:
a processor; and
a memory communicatively coupled to the processor, wherein the memory stores processor instructions, which when executed by the processor, cause the processor to:
receive video data of an area from each of one or more cameras, wherein the video data comprises a plurality of frames;
for each frame of the plurality of frames,
generate in real-time, by an Artificial Intelligence (AI) model, a space-time-behaviour dataset corresponding to the frame, wherein the space-time-behaviour dataset comprises spatial data, temporal data, and behavioural data corresponding to the area, and wherein the behavioural data corresponds to actions and facial expressions of one or more humans present in the frame;
identify in real-time, by the AI model, at least one of:
an event from a plurality of predefined events, or
an associated cause of an event from a plurality of predefined causes,
based on the space-time-behaviour dataset, wherein each of the plurality of predefined causes is associated with a predefined space-time-behaviour dataset;
determine in real-time, by the AI model, at least one of a set of cause parameters corresponding to the cause or a set of event parameters corresponding to the event, based on the space-time-behaviour dataset;
compare in real-time, by the AI model, the set of cause parameters with corresponding cause parameters of the plurality of predefined causes, and the set of event parameters with corresponding event parameters of the plurality of predefined events; and
determine in real-time, by the AI model, whether at least one of the cause or the event corresponds to suspicious activity based on the comparison.

10. The system of claim 9, wherein the processor instructions, on execution, further cause the processor to store the plurality of predefined events and the associated plurality of predefined causes in at least one repository.

11. The system of claim 10, wherein the processor instructions, on execution, further cause the processor to, when the at least one of the cause or the event is determined as a suspicious activity, automatically update the at least one repository with the set of cause parameters and the set of event parameters.

12. The system of claim 11, wherein the processor instructions, on execution, further cause the processor to self-adaptively train the AI model using the at least one updated repository, wherein adaptively training comprises modifying in real-time or near real-time, a set of parameters of the AI model based on the at least one updated repository.

13. The system of claim 10, wherein the at least one repository comprises a signature library corresponding to each of a plurality of suspicious activities.

14. The system of claim 10, wherein the at least one repository comprises a geolocation-specific library corresponding to each of a plurality of suspicious activities and a shared signature library, wherein the geolocation-specific library comprises the predefined space-time-behaviour dataset corresponding to a geolocation, and wherein the shared signature library comprises the predefined space-time-behaviour dataset corresponding to each of a set of geolocations.

15. The system of claim 10, wherein the processor instructions, on execution, further cause the processor to:
identify in real-time, by the AI model, one or more humans present in the frame;
when the at least one of the cause or the event is determined as a suspicious activity, store identification details of the one or more humans in the at least one repository; and
notify in real-time, an administrator at a subsequent time instance when in a subsequent frame:
the one or more humans are identified through the identification details, and
at least one of a premature cause or a cause associated with a suspicious activity is identified.

16. The system of claim 9, wherein the processor instructions, on execution, further cause the processor to notify in real-time, an administrator of the determined suspicious activity when the at least one of the cause or the event is determined as a suspicious activity.

17. A non-transitory computer-readable medium storing computer-executable instructions for monitoring activities and events in real-time, the computer-executable instructions configured for:
receiving video data of an area from each of one or more cameras, wherein the video data comprises a plurality of frames;
for each frame of the plurality of frames,
generating in real-time, by an Artificial Intelligence (AI) model, a space-time-behaviour dataset corresponding to the frame, wherein the space-time-behaviour dataset comprises spatial data, temporal data, and behavioural data corresponding to the area, and wherein the behavioural data corresponds to actions and facial expressions of one or more humans present in the frame;
identifying in real-time, by the AI model, at least one of:
an event from a plurality of predefined events, or
an associated cause of an event from a plurality of predefined causes,
based on the space-time-behaviour dataset, wherein each of the plurality of predefined causes is associated with a predefined space-time-behaviour dataset;
determining in real-time, by the AI model, at least one of a set of cause parameters corresponding to the cause or a set of event parameters corresponding to the event, based on the space-time-behaviour dataset;
comparing in real-time, by the AI model, the set of cause parameters with corresponding cause parameters of the plurality of predefined causes, and the set of event parameters with corresponding event parameters of the plurality of predefined events; and
determining in real-time, by the AI model, whether at least one of the cause or the event corresponds to suspicious activity based on the comparison.

18. The non-transitory computer-readable medium of claim 17, further comprising storing the plurality of predefined events and the associated plurality of predefined causes in at least one repository.

19. The non-transitory computer-readable medium of claim 18, further comprising, when the at least one of the cause or the event is determined as a suspicious activity, automatically updating the at least one repository with the set of cause parameters and the set of event parameters.

20. The non-transitory computer-readable medium of claim 18, further comprising:
identifying in real-time, by the AI model, one or more humans present in the frame;
when the at least one of the cause or the event is determined as a suspicious activity, storing identification details of the one or more humans in the at least one repository; and
notifying in real-time, an administrator at a subsequent time instance when in a subsequent frame:
the one or more humans are identified through the identification details, and
at least one of a premature cause or a cause associated with a suspicious activity is identified.
